(19) United States
(12) Patent Application Publication
(10) Pub. No.: US 2002/0146219 A1
(43) Pub. Date: Oct. 10, 2002

(54) Optical fiber socket with a chip seat

(76) Inventor: Yu-Feng Cheng, Tucheng City (TW)

Correspondence Address: DELLETT AND WALTERS, 310 S.W. FOURTH AVENUE, SUITE 1101, PORTLAND, OR, 97204, US

(21) Appl. No.: 09/829,537

(22) Filed: Apr. 9, 2001

(51) Int. Cl. G02B 6/42

(52) U.S. Cl. 385/92

(57) ABSTRACT

An optical fiber socket with a chip seat is consisted of a housing, a signal-transforming chip installed inside the housing, and a chip seat enclosing the signal-transforming chip inside the housing, therefore the signal-transforming chip is changeable to avoid waste of other parts of the socket when the chip malfunctions.

### BACKGROUND OF THE INVENTION

1. Field of the Invention

The present invention relates to an optical fiber socket with a chip seat wherein a signal-transforming chip is installed inside the socket and enclosed by the chip seat, and such a fixing manner substitutes conventionally immovable sealing of the chip.

2. Description of Related Art

Electrical equipment at the present such as communicating devices, domestic appliances, etc, uses electric cables as means of signal transmission. However, it is generally known that the electric cables have high resistance and reduce the strength of the signal, particularly over very long distances. Therefore, the electric cables are not efficient for signals in long-distance transmission.

Additionally, the electric cables can not deal with a huge quantity of signals, especially video and audio signals, and this makes the transmissions slow down. Optical fiber cable, which has low signal loss, high carrying capacity, and is not subject to electromagnetic interference, has replaced the electric cable.

When the optical fiber cable is fitted the electric equipment, a signal-transforming chip is needed to translate the optical signal to an electrical signal, and a corresponding socket is also needed to contain the signal-transforming chip.

A conventional optical fiber socket (50) as shown in FIG. 4 has a compartment (51) vertically defined in a rear portion of the socket (50) to receive a signal-transforming chip (52). A plug chamber (53) is transversally defined in a front portion of the socket to receive an optical fiber plug and communicate with the compartment (51). When the signal-transforming chip (52) is inserted into the compartment (51) of the socket (50), sealing material is injected into the compartment (51), and when the sealing material dries the signal-transforming chip (52) is immovably contained inside the compartment (51).

However, sealing the signal-transforming chip (52) is time-consuming because of waiting for the sealing material to dry and harden. Because the signal-transforming chip (52) is fixed inside the socket (50), if the signal-transforming chip (52) malfunctions, the whole socket (50) with the sealed signal-transforming chip (52) has to be abandoned which leads to harm to the environment and causes excessive production costs for manufacturers.

In order to overcome those problems, the present invention tends to provide an optical fiber socket with a chip seat to mitigate and obviate the aforementioned problems.

### SUMMARY OF THE INVENTION

The main objective of the invention is to provide an optical fiber socket with a chip seat to enclose a signal-transforming chip firmly inside the socket.

Another objective of the invention is that the chip seat is detachable so that a malfunctioning signal-transforming chip can be changed to avoid material wastage and harm to the environment.

Other objects, advantages and novel features of the invention will become more apparent from the following detailed description when taken in conjunction with the accompanying drawings.

### BRIEF DESCRIPTION OF THE DRAWINGS

FIG. 1 is an exploded view of an optical fiber socket with a chip seat;

FIG. 2 is a side cross-section view of a housing of the optical fiber socket;

FIG. 3 is a side cross-section view of the housing when a signal-transforming chip is received inside; and

FIG. 4 is a perspective view of a conventional optical fiber socket.

### DETAILED DESCRIPTION OF THE PREFERRED EMBODIMENT

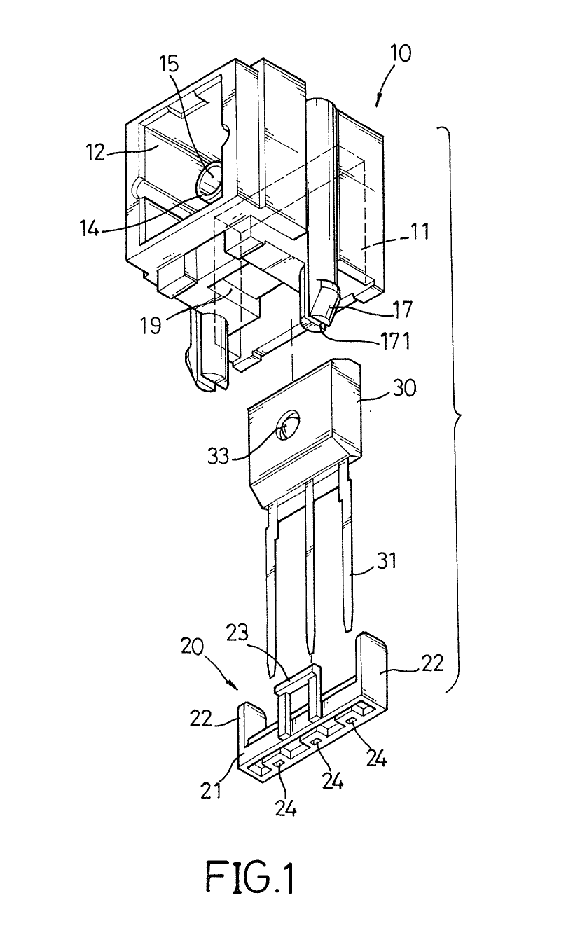

With reference to FIG. 1, an optical fiber socket with a chip seat is composed of a housing (10), a chip seat (20) and a signal-transforming chip (30).

The housing (10) has a chip container (11) defined vertically in a first end portion thereof, and a plug chamber (12) defined transversally in a second end portion of the housing (10). The chip container (11) has an opening (19) defined in an under face of the first end portion and the plug chamber (12) has an exit defined in a front face of the second end portion. A pin receiver (14) is transversally formed inside the plug chamber (12) and has a passageway (15) defined therein to communicate with the chip container (11). Two feet (17) are formed respectively and vertically on opposite outside surfaces of the housing (10) and the feet (17) are disposed between the first end portion and the second end portion, and each foot (17) has slit (171) defined in a distal end thereof to combine with a circuit board or similar.

The chip seat (20) has a bottom board (21), two arms (22) protruding respectively and upwardly from opposite narrow ends of the bottom board (21), and a resilient stub (23) with two feet formed on a side-face of the bottom board (21) and a top bar integrally extending between tops of the feet. Moreover, multiple through holes (24) are defined in the bottom board (21).

The signal-transforming chip (30) has a plurality of filaments (31) to penetrate the through holes (24) of the chip seat (20) whereby the chip (30) and the chip seat (20) are combined, and a chip eye (33) to receive signals from an optical fiber cable.

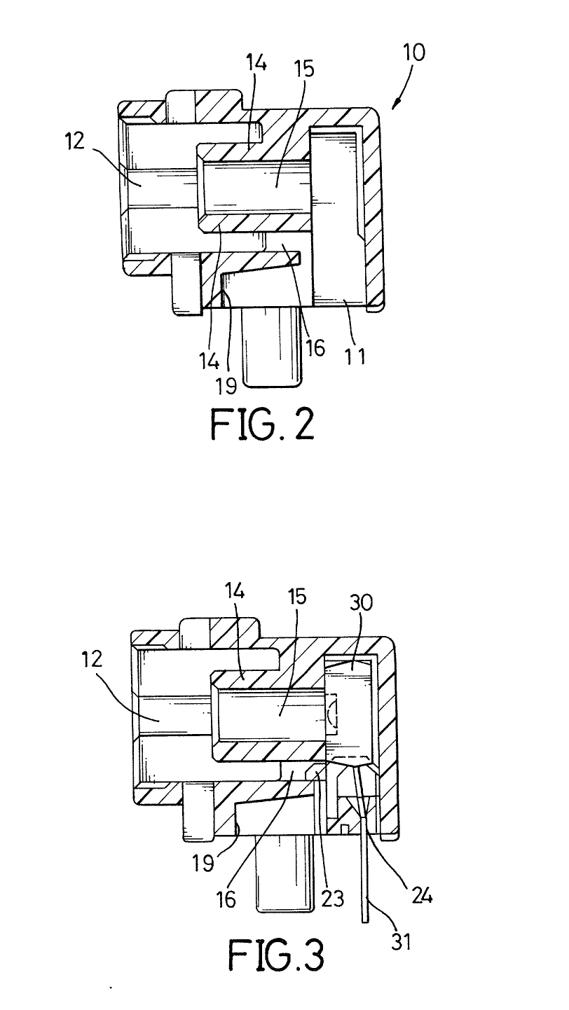

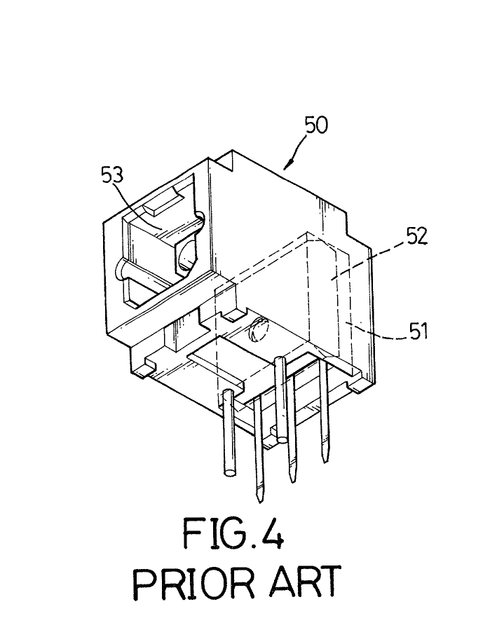

Now referring to FIGS. 2 and 3, in the housing (10), a trench (16) is formed between the pin receiver (14) and a bottom face of the housing (10), and the trench (16) communicates with both the opening (19) and the chip container (11). Therefore when the combined signal-transforming chip (30) and chip seat (20) are inserted inside the chip container (11), the top bar of the stub (23) of the chip seat (20) is first pushed back due to interfering with a wall of the chip seat (20) until it reaches the trench (16) whereafter the top bar springs back to its original position and wedges into the trench (16) to securely retain the signal-transforming chip (30) in the chip container (11). The chip eye (33) aligns with the passageway (15) and the fitted optical fiber cable to receive optical signals.

According to the above description, the signal-transforming chip (30) is changeable by a user inserting a pencil tip or similar into the opening (19) to push the feet and thus the top bar from its engagement with the trench (16). The user then pulls the filaments (31) down from the housing (11) whereby the combined chip seat (20) and signal-transforming chip (30) are extracted from the chip container (11) of the housing (10) to allow reuse of the other parts of the socket, instead of abandoning the entire unit. It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical fiber socket with a chip seat comprising:
a housing having a chip container adapted to receive therein a chip, a plug chamber defined in the housing to receive the plug, and a pin receiver formed inside the plug chamber and having a passageway defined to communicate with the chip container, and a trench defined between the pin receiver and a bottom face of the housing; and
a chip seat having a bottom board with multiple through holes defined therein and a stub adhered to the bottom board able to be secured inside the trench of the housing.

2. The optical fiber socket with a chip seat as claimed in claim 1, wherein the housing has two feet each formed vertically on two opposite outside surfaces of the housing and having a slit defined for securing the housing to an electric circuit board.

3. The optical fiber socket with a chip seat as claimed in claim 1, wherein the chip seat has two arms protruding respectively and upwardly from opposite ends of the bottom board to stay close to inner walls of the chip container and enhance fixing ability.

4. The optical fiber socket with a chip seat as claimed in claim 2, wherein the chip seat has two arms protruding respectively and upwardly from opposite narrow ends of the bottom to correspond to the chip container.

5. The optical fiber socket with a chip seat as claimed in claim 3, wherein the bottom board of the chip seat has multiple through holes adapted to be penetrated by a plurality of filaments of the chip.

6. The optical fiber socket with a chip seat as claimed in claim 4, wherein the bottom board of the chip seat has multiple through holes adapted to be penetrated by a plurality of filaments of the chip.
